(19) United States
(12) Patent Application Publication
(10) Pub. No.: US 2026/0337370 A1
(43) Pub. Date: Oct. 29, 2026

(54) SEALING ELEMENT SUITABLE AS HYDROGEN BARRIER

(71) Applicant: TRITON HYDROGEN LTD., Newcastle (GB)

(72) Inventor: Gerd THÖNE, Bad Salzuflen (DE)

(21) Appl. No.: 19/104,042

(22) PCT Filed: Oct. 10, 2022
(86) PCT No.: PCT/EP2022/078047

§ 371 Date: Feb. 14, 2025

(30) Foreign Application Priority Data
Aug. 19, 2022 (DE) 10 2022 121 004.9
Sep. 8, 2022 (DE) 10 2022 122 802.9

(51) Int. Cl. C08K 3/08; C08K 5/00; C09D 7/40; C09D 7/61; C09D 7/63

(52) U.S. Cl. CPC C08K 3/08; C08K 5/0016; C09D 7/61; C09D 7/63; C09D 7/66; C08K 2003/0812; C08K 2003/0893; C08K 2201/005; C08K 2201/011

(57) ABSTRACT

A sealing element which is suitable as a hydrogen barrier and has a base material. A matrix material for fiber composite materials having a base material is also related. The sealing element or the matrix material contains a plasticizer, nano-silicon dioxide, aluminum powder and zinc powder.

### CROSS-REFERENCE TO RELATED APPLICATIONS

This application is a 35 U.S.C. § 371 National Stage patent application of PCT/EP 2022/078047 filed on 10 Oct. 2022, which claims the benefit of both German patent application no. 10 2022 121 004.9, filed on 19 Aug. 2022 and German patent application no. 10 2022 122 802.9, filed on 8 Sep. 2022, the disclosures of which are incorporated herein by reference in their entirety.

### TECHNICAL FIELD

The disclosure relates to a sealing element, a method for the manufacture of the sealing element, a matrix material for fibre composite materials, and a method for the manufacture of the matrix material, wherein the sealing element and the matrix material are utilisable as a hydrogen barrier.

### BACKGROUND

The energy carrier hydrogen is becoming more and more important in the changeo-ver to renewable energy sources. Hydrogen can be produced at renewable energy-rich locations and can be transported from there to the conurbations where the energy is principally consumed. The energy can also be temporarily stored or stocked in the form of hydrogen very successfully. For this transport and storage, however, vessels and pipelines are required, via which the hydrogen can be transported or in which the hydrogen can be stored. As a rule, such vessels and pipelines are manufactured from steel or can be manufactured from fibre composite materials.

The hydrogen atom is the smallest atom in the periodic table, which places particular demands on the materials from which the vessels or pipelines for the hydrogen are manufactured; this is because, due to its size, hydrogen has a tendency to penetrate into materials such as steel or fibre composite materials.

The degree to which a material tends to take up or allow hydrogen to permeate through it can be determined with the aid of permeability measurements according to DIN EN ISO 17081 and in accordance with EP 3 553 210 A1. Here, a sample of material is placed between two electrodes, whereupon a current flows between the two electrodes when hydrogen diffuses through the sample of material. The higher the detected current, the greater is the hydrogen diffusion through the material sample, and vice versa. In the case of steel and in the case of fibre composite materials, here, considerable diffusion of hydrogen occurs through the material.

Once hydrogen has penetrated into the materials, in the case of the steel grades normally used in vessel construction and pipeline construction, this leads to a change in the crystal structures of the steel and therefore to a mechanical weakening of the steel. Fibre composite materials with a matrix of epoxy resin, for example, tend to become brittle. The vessels and pipelines produced from steel or fibre composite materials therefore lose their mechanical strength over time and have to be changed.

### SUMMARY

Thus, the disclosure provides a sealing element and a matrix material for fibre-reinforced plastics which has as high a resistance to the diffusion of or permeability of hydrogen as possible, in order to increase the service life of vessels and pipelines and at the same time, be inexpensive to manufacture as well as easy to process.

This is achieved by providing the articles and method with the features of the inde-pendent claims in the present application. Other particularly advantageous embodiments of the disclosure are disclosed in the respective dependent claims.

It should be noted that the individually specified features in the claims may be combined together in any technically feasible manner (even across different categories, for example between method and device) and illustrate other embodiments of the disclosure. In addition, the description characterizes and specifies the disclosure, in particular in relation to the figures.

It should further be noted that a conjunction “and/or” placed between and linking two features as used herein should always be interpreted such that in a first embodiment of the subject matter of the disclosure, only the first feature may be present, in a second embodiment only the second feature may be present, and in a third embodiment, both the first and also the second feature may be present.

The sealing element in accordance with the disclosure utilisable as a hydrogen barrier with a base material is characterized in that the sealing element comprises plasticizer, nanosilicon dioxide, aluminium powder and zinc powder.

The sealing element is suitable as a barrier to hydrogen, which means that essentially, the hydrogen cannot pass through the sealing element. “Essentially not pass through” as used in the context of the application means that the hydrogen pene-trating through the sealing element corresponds to less than 5%, preferably less than 2%, more preferably less than 1% of the quantity of hydrogen which would otherwise penetrate into the surface to be sealed in the absence of a sealing element.

The sealing element can be used as a barrier to hydrogen because the hydrogen molecules are adsorbed by the sealing element and/or because they cannot penetrate into the sealing element material at all. Thus, materials such as steel or fibre composite materials can be sealed with the sealing element, so that no more hydrogen can reach the steel or fibre composite material via the sealed surface, and so damage to the materials by the hydrogen can be prevented.

A dispersion base, which is often used in facade paints, for example, may be used as the base material. This means that, as is customary with facade coatings, the sealing element can be applied to the surfaces to be protected very easily. In the dry state of the sealing element, the full protective effect is present, but this may also already be present in the as-yet not dry, liquid state.

The layer thickness should be in the range of 0.2 mm to 1 mm, preferably 0.5 mm, so that a certain mechanical stability and mechanical performance of the sealing element is ensured. In practice, two successive coats each of 0.25 mm have been shown to be sufficient. The protective effect only requires that the surface of the sealing element is sealed, and so the layer thickness can be very small, for example less than 0.2 mm.

It is known that aluminium-based additives can compromise the permeability of materials to hydrogen. However, aluminium in most conventional dispersion-based materials leads to a crack formation and/or pore formation when the sealing element dries, so that although the hydrogen can no longer penetrate through the sealing element per se, it can penetrate via the cracks and pores, so that the surface to be protected against the hydrogen is in fact no longer protected.

Thus, the central concept of the disclosure is that, in addition to aluminium powder, zinc powder, nanosilicon dioxide and plasticizer are also added to the sealing element, so that after drying of the sealing element, a contiguous layer remains on the surface to be sealed, which on the one hand in itself has a very low, preferably zero permeability as regards hydrogen, and at the same time has substantially no cracks or through-pores through which the hydrogen could reach the surface to be protected.

In this regard, the plasticizer serves to provide the matrix of the sealing element with a certain elasticity, so that fewer or, as far as possible, no cracks and pores are produced upon drying of the sealing element. The nanosilicon dioxide also makes a substantial contribution to the fact that fewer pores and cracks are produced upon drying of the sealing element.

The aluminium powder and the zinc powder form plate-like structures which strengthen the matrix of the sealing element in the manner of a reinforcement. These structures produced from aluminium and zinc ultimately lead to the impermeability of the sealing element as regards hydrogen.

Advantageous embodiments and variations of the disclosure are defined in the dependent claims and in the description below. The individual features defined in the dependent claims can be combined in any technically feasible manner, both together and also with the features described in more detail in the description below, constituting other advantageous variational embodiments.

In one embodiment of the sealing element, the base material comprises pure acrylate and/or styrene acrylate and/or styrene-butadiene. Preferably, the base material solely comprises one of these materials or a combination thereof.

Pure acrylate now dominates as the basis for facade paints because it is less dam-aging to health than, for example, nitro-based paints or alkyd resin varnishes, and in addition they have very good properties such as UV resistance and coverage. Fur-thermore, because pure acrylate is widely available, it is inexpensive and the quality is good. When mention is made of pure acrylate in this application, this preferably means a dispersion of methyl acrylate and water which contains a proportion of solids of 35-45%, preferably 40%, and preferably an emulsifier such as Pemulen, for example, in an amount of 2-4%, preferably 3%.

In addition to pure acrylate, however, styrene acrylate and styrene-butadiene are also suitable. These materials provide the sealing element with better mechanical strength and may, for example, be used where surfaces which are exposed to a higher mechanical loading have to be sealed.

In a further embodiment of the sealing element, the plasticizer comprises Plastilit 3060 from BASF and/or APEO-free polypropylene glycol alkylphenyl ether. Preferably, the plasticizer comprises one of these materials or of a combination thereof.

In a further embodiment of the sealing element, the nanosilicon dioxide, preferably substantially in its entirety, has a particle size of less than 10 nm. Nanosilicon dioxide is characterized by a particle size in the nanoscale range. Advantageously, the particle size of the particles is less than 10 nm. Because, as a rule, powder has a distri-bution of grain sizes, the particles are substantially in a particle size of below 10 nm, which means, for example, that at least 90% of the particles have a particle size of less than 10 nm.

In a further embodiment of the sealing element, the aluminium powder has a mean grain size of 0.1-50 μm, preferably a mean grain size of 30 μm. The mean grain size describes the grain size in a powder which is the most frequent. Larger and smaller grains are present in smaller proportions, for example in a Gaussian distri-bution,

In a further embodiment of the sealing element, the zinc powder has a mean grain size of 0.1-50 μm, preferably a mean grain size of 50 μm.

In a further embodiment of the sealing element, the sealing element has materials in the following designated proportions:
a. 50-90% pure acrylate and/or
b. 1-3% white spirit and/or
c. 0.1-1.0% preservative and/or
d. 1-5% nanosilicon dioxide and/or
e. 3-10% plasticizer and/or
f. 1-10% aluminium powder and/or
g. 1-10% zinc powder and/or
h. 0.5-30% water.

A sealing element with the proportions of the respective materials given above is extremely suitable as a hydrogen barrier.

White spirit is a mineral spirit and serves to reduce the setting temperature of the sealing element. Preventol (phenylphenol), for example, may be used as a preservative.

It transpires that a sealing element composition with the following materials in the following proportions is particularly preferred:
a. 80% pure acrylate and/or
b. 2% white spirit and/or
c. 0.3% preservative and/or
d. 2% nanosilicon dioxide and/or
e. 5% plasticizer and/or
f. 2% aluminium powder and/or
g. 5% zinc powder and/or
h. 3.7% water.

In laboratory tests according to DIN EN ISO 17081 and in accordance with EP 3 553 210 A1, such a sealing element has been shown to be completely impermeable to hydrogen.

A substrate sealed with a sealing element in accordance with the disclosure is characterized in that the sealing element comprises plasticizer, nanosilicon dioxide, aluminium powder and zinc powder.

In one embodiment of the sealed substrate, the sealing element is disposed on a surface of the substrate in a layer thickness of at least 0.2 mm. Preferably, the sealing element has been applied in two layers, so that the dry sealing element on the substrate is formed from two layers each of at least 0.1 mm.

In a further embodiment of the sealed substrate, the substrate comprises iron and/or steel and/or fibre-reinforced plastic. Preferably, the substrate comprises one or more of the aforementioned materials, Preferably, the substrate forms a pipeline or a vessel for the transport or storage of hydrogen. The substrate may also form any of the elements which could come into contact with the hydrogen in pipeline construction or vessel construction, such as valves, bushings or fittings, for example.

In addition to the sealing element, a method in accordance with the disclosure is claimed for the manufacture of the sealing element utilisable as a hydrogen barrier with a base material. The method is characterized in that plasticizer, nanosilicon dioxide, aluminium powder and zinc powder are added to the base material in a mixing process using mechanical mixing.

In the mixing process, the individual components of the sealing element are added little by little to the base material and mixed together, for example under continuous stirring using an agitator. What is important is that, as far as possible, the mechanical mixing is free from foaming.

In one embodiment of the method, during the manufacture of the sealing element, the mechanical mixing is carried out under vacuum. When mixing mechanically, it is important that as far as possible, no air bubbles are introduced into the sealing element, because these could later give rise to pores in the sealing element. Thus, it is advantageous for the mechanical mixing to be carried out under vacuum, so that no air bubbles are mixed into the sealing element. It may also be expedient for any air bubbles which have been mixed in after mechanical mixing to be removed from the sealing element by application of a vacuum.

In a further embodiment of the method for the manufacture of the sealing element, the materials (base material, plasticizer, nanosilicon dioxide, aluminium powder and zinc powder, as well as any other additives) which have already been mechanically mixed are supplied to a colloider for processing. This results in the components of the sealing element being mixed through as finely as possible and thus the aluminium powder and the zinc powder can form plate-like structures during setting of the sealing element, leading to reinforcing the sealing element.

The disclosure also encompasses a matrix material for a fibre composite material utilisable as a hydrogen barrier, with a base material, and which is characterized in that the matrix material comprises plasticizer, nanosilicon dioxide, aluminium powder and zinc powder. The plasticizer, the nanosilicon dioxide, the aluminium powder and the zinc powder also result in an impermeability as regards hydrogen in a matrix material for fibre composite materials. A fibre composite material with the matrix material in accordance with the disclosure is therefore impermeable in itself as regards hydrogen and does not need to be protected against the penetration of hydrogen by an additional sealing element.

In a preferred embodiment of the matrix material, the base material comprises a 2K material. 2K materials have the advantage that the setting process can be adjusted precisely, and frequently, they provide a very good solvent resistance following setting.

In a further preferred embodiment of the matrix material, the base material comprises pure acrylate. Epoxy resin is widely used as a matrix material and has proven its worth. However, because epoxy resin becomes brittle on contact with hydrogen and, moreover, tends to form pores and cracks on setting, another base material has to be employed. It has transpired that pure acrylate can be used as the base material for the matrix material and can be made impermeable to hydrogen by the additives in accordance with the disclosure.

A fibre composite plastic material in accordance with the disclosure comprises a fibrous material and a matrix material and is characterized in that the matrix material comprises plasticizer, nanosilicon dioxide, aluminium powder and zinc powder,

In one embodiment of the fibre composite plastic material, the fibrous material is embedded in the matrix material. The fibrous material is therefore substantially completely surrounded by the matrix material, wherein “substantially completely” in the context of the application means that, for example at its ends at subsequently cut edges of a component produced from the fibre composite plastic material, the fibrous material does not necessarily have to be surrounded by matrix material.

In a further embodiment of the fibre composite plastic material, the fibrous material comprises glass fibres and/or carbon fibres and/or Kevlar fibres and/or natural fibres and/or metal fibres. Preferably, the fibrous material comprises one or more of the aforementioned materials.

A method in accordance with the disclosure for the manufacture of a matrix material for a fibre composite material utilisable as a hydrogen barrier with a base material is characterized in that plasticizer, nanosilicon dioxide, aluminium powder and zinc powder are added to the base material in a mixing process with mechanical mixing. In one embodiment of the method, during the manufacture of the matrix material, the mechanical mixing is carried out under vacuum. During mechanical mixing, it is important that as far as possible, no air bubbles are introduced into the matrix material, because this results in pores in the matrix material. Thus, advantageously, the mechanical mixing is carried out under vacuum, so that no air bubbles are mixed into the matrix material. It may also be expedient for any air bubbles which have been mixed in after mechanical mixing to be removed from the matrix material by the application of a vacuum.

In a further preferred embodiment for the manufacture of the matrix material, the previously mechanically mixed materials (base material, plasticizer, nanosilicon dioxide, aluminium powder and zinc powder, as well as any additives) are supplied to a colloider for processing. This has the consequence that the aluminium powder and the zinc powder can form plate-like structures during setting of the sealing element, which leads to reinforcing of the sealing element.

### BRIEF DESCRIPTION OF THE DRAWINGS

The present disclosure will now be explained in more detail with the aid of exemplary embodiments and with reference to the accompanying figures, in which:

FIG. 1 shows a sealed substrate, with a substrate in the form of a steel pipe with a sealing element in accordance with the disclosure disposed on

FIG. 2 shows a fibre composite plastic material with a fibrous material embedded in a matrix material in accordance with the disclosure, and

FIG. 3 shows a sealed substrate produced from steel with a sealing element in accordance with the disclosure disposed on one side.

### DETAILED DESCRIPTION OF THE DRAWINGS

In the figures-unless stated otherwise-identical reference numerals designate identical or mutually corresponding components with identical functions.

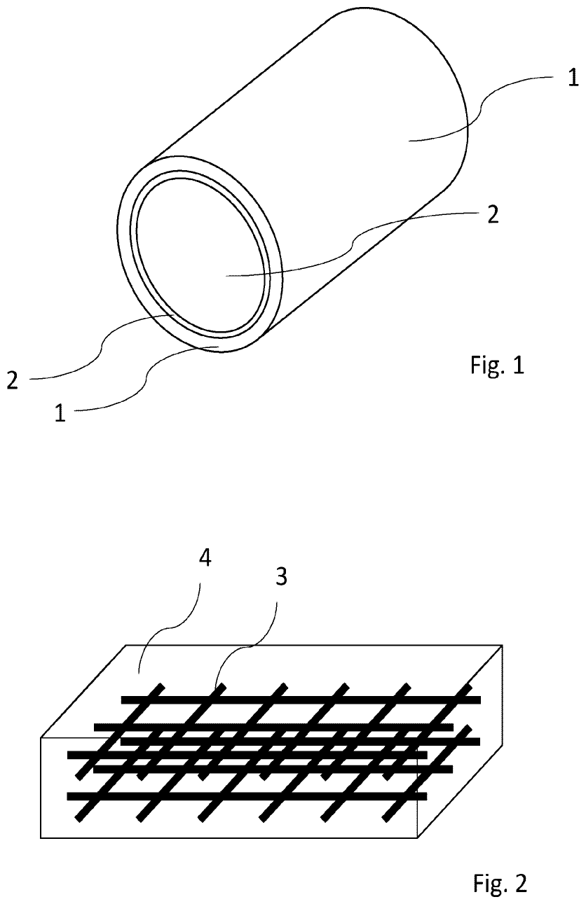

FIG. 1 shows a sealed substrate with a substrate 1 in the form of a steel pipe with a sealing element 2 disposed on the interior side of the steel pipe. Here, the sealing element 2 is applied in a layer which is thin compared with the wall of the steel pipe, wherein its thickness is 0.2 mm, while that of the wall of the steel pipe is 3 mm. Because of the sealing element 2, no hydrogen can penetrate through, so that the interior side of the steel pipe cannot come into contact with the hydrogen. This means that in addition, no hydrogen can reach the external surroundings through the steel pipe.

FIG. 2 shows a fibre composite plastic material with a fibrous material 3 embedded in a matrix material 4. The matrix material 4 here completely surrounds the fibres of the fibrous material 3 and is chemically cured, so that a mechanically stable fibre composite plastic material is formed from the fibrous material 3 and the matrix material.

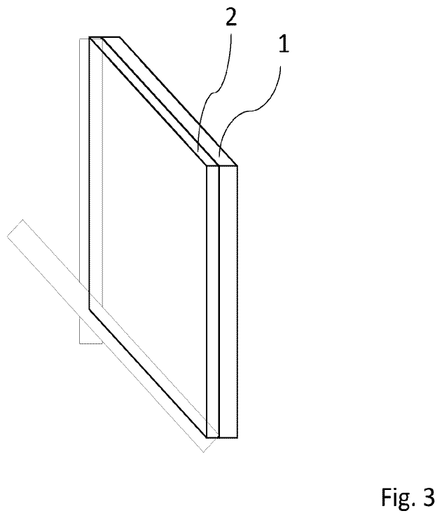

FIG. 3 shows a sealed substrate 1 produced from steel with a sealing element 2 in accordance with the disclosure disposed on one side. The sealing element 2 here has been applied to one side of the steel substrate 1 in two layers, each with a layer thickness of approximately 0.1 mm.

The sealing element has a composition with the following materials in the following proportions:
c. 0.3% preservative and/or
d. 2% nanosilicon dioxide and/or
e. 5% plasticizer and/or
f. 2% aluminium powder and/or
g. 5% zinc powder and/or
h. 3.7% water.

The substrate 1 from FIG. 3 sealed on one side with the sealing element 2 underwent a permeation measurement according to DIN EN ISO 17081 and in accordance with EP 3 553 210 A1 with the aid of an electrochemical measuring device. In the laboratory tests which were carried out, the sealing element 1 proved to be completely impermeable to hydrogen.

1. A sealing element utilisable as a hydrogen barrier, with a base material,
wherein the sealing element comprises plasticizer, nanosilicon dioxide, aluminium powder, and zinc powder.

2. The sealing element claim 1,
wherein the base material comprises pure acrylate and/or styrene acrylate and/or styrene-butadiene.

3. The sealing element of claim 1,
wherein the plasticizer comprises Plastilit and/or free polypropylene glycol alkylphenylether.

4. The sealing element of claim 1,
wherein the nanosilicon dioxide has a particle size of less than 10 nm.

5. The sealing element of claim 1,
wherein the aluminium powder has a mean grain size of 0.1-50 μm.

6. The sealing element of claim 1,
wherein the zinc powder has a mean grain size of 0.1-50 μm.

7. The sealing element of claim 1,
wherein the sealing element has materials in the following designated proportions:
a. 50-90% pure acrylate and/or
b. 1-3% white spirit and/or
c. 0.1-1.0% preservative and/or
d. 1-5% nanosilicon dioxide and/or
e. 3-10% plasticizer and/or
f. 1-10% aluminium powder and/or
g. 1-10% zinc powder and/or
h. 0.5-30% water.

8. A sealed substrate with the sealing element of claim 1,
wherein the sealing element comprises plasticizer, nanosilicon dioxide, aluminium powder, and zinc powder.

9. The sealed substrate of claim 8,
wherein the sealing element is disposed on a surface of the substrate in a layer thickness of at least 0.2 mm.

10. The sealed substrate of claim 8, wherein the substrate comprises iron and/or steel and/or fibre-reinforced plastic.

11. A method for the manufacture of a sealing element utilisable as a hydrogen barrier, with a base material,
wherein plasticizer, nanosilicon dioxide, aluminium powder and zinc powder are added to the base material in a mixing process using mechanical mixing.

12. The method of claim 11,
wherein during the manufacture of the sealing element, the mechanical mixing is carried out under vacuum.

13. The method of claim 11,
wherein during the manufacture of the sealing element, a colloider is used for processing the mechanically mixed materials.

14. A matrix material for a fibre composite plastic material utilisable as a hydrogen barrier, with a base material,
wherein the matrix material comprises plasticizer, nanosilicon dioxide, aluminium powder, and zinc powder.

15. The matrix material of claim 14,
wherein the base material comprises a 2K material.

16. The matrix material of claim 14,
wherein the base material comprises pure acrylate.

17. A fibre composite plastic material comprising a fibrous material and a matrix material of claim 14,
wherein the matrix material comprises plasticizer, nanosilicon dioxide, aluminium powder and zinc powder.

18. The fibre composite plastic material of claim 17,
wherein the fibrous material is embedded in the matrix material.

19. The fibre composite plastic material of claim 17,
wherein the fibrous material comprises glass fibres and/or carbon fibres and/or Kevlar fibres and/or natural fibres and/or metal fibres.

20. A method for the manufacture of a matrix material for a fibre composite material utilisable as a hydrogen barrier, with a base material, including the step of adding plasticizer, nanosilicon dioxide, aluminium powder and zinc powder to the base material in a mixing process with mechanical mixing.

21. The method of claim 20, further including the step of carrying out the mechanical mixing under vacuum during the manufacture of the matrix material.

22. The method of claim 20,
further including the step of using colloider for processing the mechanically mixed materials during the manufacture of a matrix material, wherein the matrix material is for a fibre composite plastic material utilisable as a hydrogen barrier, with a base material, and the matrix material comprises plasticizer, nanosilicon dioxide, aluminium powder, and zinc powder.
